(19) United States
(12) Patent Application Publication
(10) Pub. No.: US 2009/0108560 A1
(43) Pub. Date: Apr. 30, 2009

(54) Foot peg with removable grip studs and slider

(75) Inventors: Scott Mountz, Irvine, CA (US); Steffen Hagene, San Jose, CA (US)

Correspondence Address: STETINA BRUNDA GARRED & BRUCKER, 75 ENTERPRISE, SUITE 250, ALISO VIEJO, CA, 92656, US

(73) Assignee: Cycle Innovations Industries, LLC

(21) Appl. No.: 11/977,905

(22) Filed: Oct. 26, 2007

(51) Int. Cl. B62J 25/00

(52) U.S. Cl. 280/291

(57) ABSTRACT

There is provided a foot peg for use on a motorized vehicle being drivable on a driving surface defining a driving surface hardness. The foot peg includes a frame being configured to engage a boot of a rider. The frame includes a frame body having frame top and bottom surfaces. The frame top surface is disposable in an upwardly facing position relative to the driving surface. The frame body additionally includes proximal and distal end portions. The foot peg also includes a slider that is attached to the frame bottom surface at the distal end portion. The slider defines a slider hardness that is less than the driving surface hardness. The foot peg additionally includes a mounting member connected to the proximal end portion of the frame body. The mounting member is engageable with the motorized vehicle, thereby enabling connection of the foot peg to the motorized vehicle.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

1. Field of the Invention

The present invention relates generally to foot pegs for use on a motorized vehicle that is drivable on a driving surface, and more particularly to a foot peg having a slider defining a slider hardness that is less than the hardness of the driving surface.

2. Description of the Related Art

Motorized vehicles are commonly used for utilitarian and recreational purposes. As such, there is a wide range of models and sizes of motorized vehicles suited for the various purposes. Certain motorized vehicles include a seat which a rider straddles while riding the vehicle. Such motorized vehicles may include, but are not limited to, motorcycles, dirt bikes, all-terrain vehicles, and the like. When the rider straddles the seat, the rider's legs and feet hang below the seat while the rider operates the vehicle. The rider's hanging lower limbs may cause discomfort for the rider, as well as create a safety hazard. In particular, the safety of the rider's legs and feet may be compromised by the motion of the vehicle. Furthermore, any exposed moving parts on the motorized vehicle, such as a rotating wheel or belt, create additional safety concerns.

Therefore, it is common for motorized vehicles to include foot pegs which provide a user with a safe resting spot for his feet. The foot pegs are typically fixed to the frame of the motorized vehicle and protrude laterally therefrom. The foot pegs include a portion which is engageable with the rider's boot. The foot pegs are typically safely positioned away from the moving parts of the motorized vehicle as well as the driving surface.

In general, a rider is in a safer riding position when his feet are positioned on the foot peg. In addition to having the rider's feet safely positioned away from the driving surface, and other moving parts, the rider is in a more compact position, thereby making it easier for the rider to maintain his balance.

The aggressive nature of riding motorized vehicles may require the rider to quickly shift his weight in order to maintain his balance. Such a riding technique may be required for a rider to safely execute a turn. The foot pegs may be used by the rider as a support to maintain his balance as the rider shifts his weight. Therefore, it is desirable that the foot peg be constructed of a material that is capable of supporting the intermittent loading caused by the weight-shifting of the rider.

Oftentimes, especially in the case of motorcycle racing, the high speed nature of riding motorized vehicles requires the rider to tilt the vehicle in order to maintain balance through a turn. In other words, the rider may be required to lean into the turn. At high speeds, the rider may lean to a point which causes the foot peg to contact and possibly scratch the driving surface, as it is typically constructed from a material having a hardness that is greater than the driving surface hardness. Such scratches may be undesirable, as they are generally costly to repair. Furthermore, the scratches tend to create an uneven driving surface, which may present a dangerous situation for the rider of the motorized vehicle, as well as other riders.

Furthermore, the abrasive nature of the contact between the foot peg and the driving surface may cause damage to the foot peg. Such contact also tends to create a rough ride for the rider. Over time, the damage may render the foot peg to be ineffective. Consequently, the excessive damage may require replacement of the entire foot peg.

As is apparent from the foregoing, there exists a need in the art for a foot peg which mitigates the scratching of the driving surface upon contact with the driving surface and allows for replacement of the portion of the foot peg that contacts the driving surface. The present invention addresses this particular need, as will be addressed in more detail below.

### BRIEF SUMMARY OF THE INVENTION

According to an aspect of the present invention, there is provided a foot peg for use on a motorized vehicle. The motorized vehicle is drivable on a driving surface defining a driving surface hardness. The foot peg includes a frame that is configured to engage with a boot of a rider. The frame includes a frame body having a frame top surface and a frame bottom surface. The frame top surface may be disposable in an upwardly facing position relative to the driving surface. The frame body additionally includes proximal and distal end portions. A slider is attached to the frame bottom surface at the distal end portion. The slider defines a slider hardness that is less than the driving surface hardness. A mounting member is connected to the proximal end portion of the frame body. The mounting member is engageable with the motorized vehicle, thereby enabling connection of the foot peg to the motorized vehicle.

It is contemplated that an aspect of the present invention includes a foot peg that will mitigate the scratching of the driving surface when the foot peg contacts the driving surface during operation of the motorized vehicle. As stated above, the hardness of the slider is less than the driving surface hardness. Therefore, the slider tends to sacrificially wear when it is brought into contact with the driving surface, rather than scratching the driving surface. Eventually, the portion of the slider that is contacting the driving surface may become so worn that it is ineffective. Therefore, the slider may be rotatable to enable another portion of the slider to be placed in position to contact the driving surface. It is contemplated that over time, the entire slider may wear to a point where it becomes inoperable. Therefore, the slider may be configured to be removable to enable replacement with a new slider. In this regard, a user may replace the slider, rather than replacing the entire foot peg, which will likely result in a quicker and less costly replacement.

The slider may be comprised of various materials being capable of sacrificially wearing as a result of such contact with the driving surface. The slider may be comprised of, but is not limited to, acrylonitrile butadiene styrene (ABS), Delrin®, and high density polyethylene. The slider may additionally be comprised of, but is not limited to, materials having a shore hardness that is less than D 100.

The foot peg may also include grip studs to enhance the engageability between the foot peg frame and the boot. The grip studs may further aid the rider in maintaining his balance on the motorized vehicle. The grip studs may be threadingly engageable with the frame body, integrally molded into the frame body, or press-fit into the frame body. In addition, the grip studs may be releasably attached to the frame body.

The present invention is best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings in which like numbers refer to like parts throughout and in which:

FIG. 1 is a top perspective view of a foot peg with a frame top surface facing upwardly, the foot peg having pointed grip studs, wherein a connection pin, shown in phantom, is used to connect the foot peg to a motorized vehicle;

FIG. 2 is a top perspective view of the foot peg with a frame bottom surface facing upwardly, the foot peg having a slider attached to the frame bottom surface;

FIG. 3 is a top perspective view of the foot peg, wherein the frame top surface is upwardly facing, the frame having flat-end grip studs attached thereto;

FIG. 4 is a top perspective exploded view of the foot peg, wherein the frame top surface is upwardly facing;

FIG. 5 is an enlarged, top perspective view of a pointed grip stud having a press-fit connector;

FIG. 6 is an enlarged, top perspective view of a flat-end grip stud having a press-fit connector;

FIG. 7 is a top perspective exploded view of the foot peg with the frame bottom surface facing upwardly, the foot peg including a capscrew and a radial screw, each being threadingly engageable to the frame body to attach the slider to the frame bottom surface;

FIG. 8 is a top perspective, lateral cutaway view of the foot peg, the foot peg having pointed grip studs including press-fit connectors;

FIG. 9 is a top perspective, longitudinal cutaway view of the foot peg, the foot peg having pointed grip studs including threaded connectors; and

FIG. 10 is a side view of the foot peg having a camber adjustment member to adjust the angular position of the foot peg relative to the motorized vehicle.

### DETAILED DESCRIPTION OF THE INVENTION

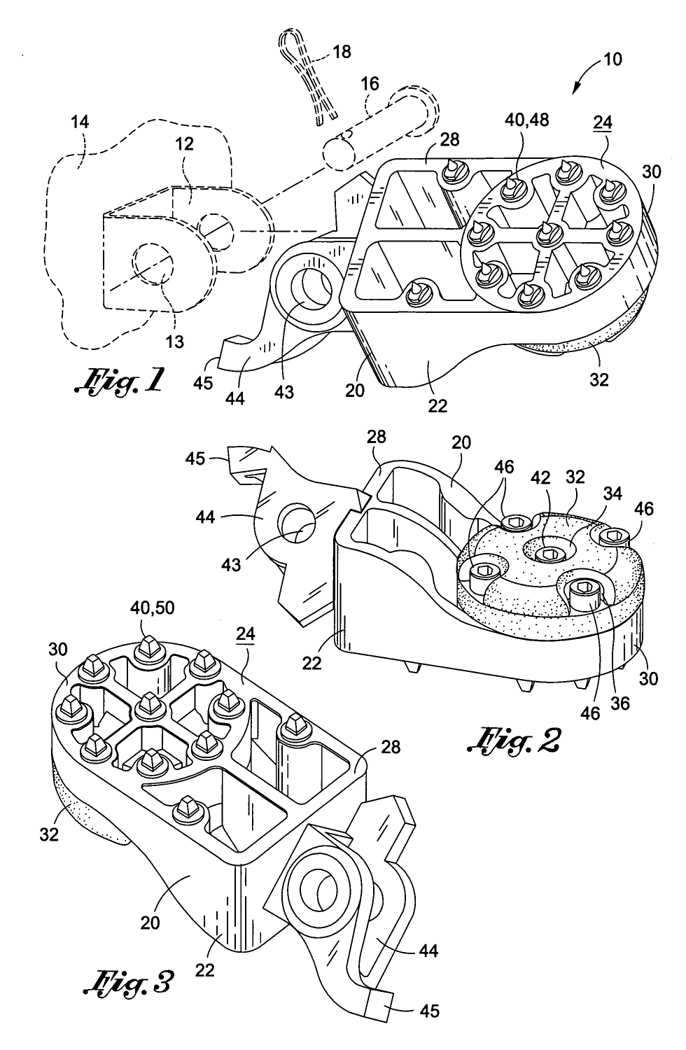

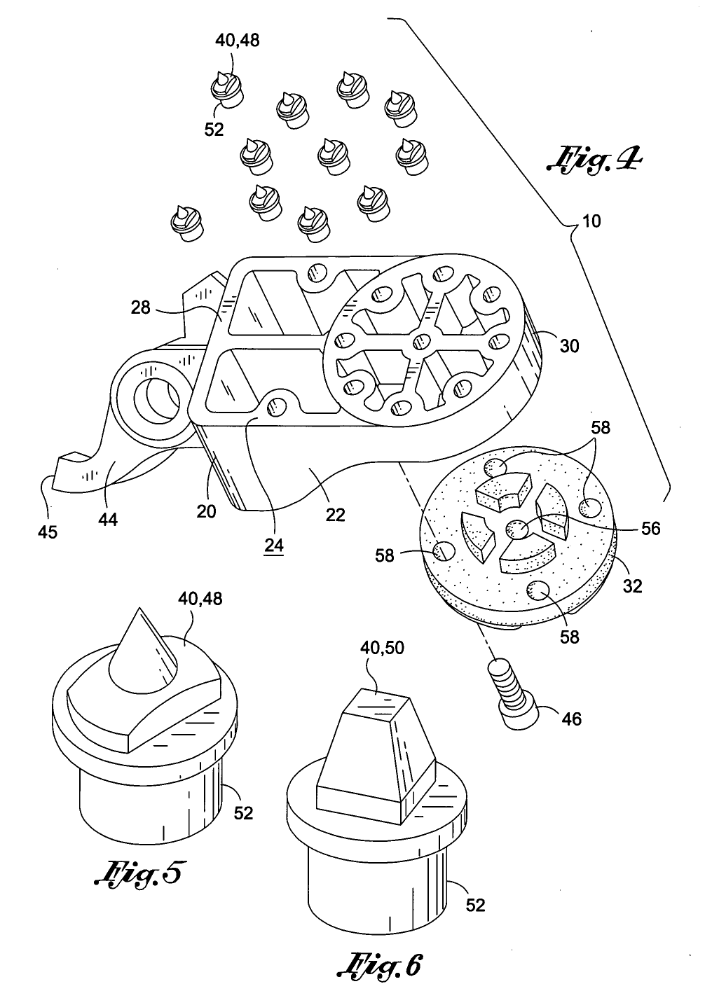

Referring now to the drawings wherein the showings are for purposes of illustrating a preferred embodiment of the present invention only, and not for purposes of limiting the same, FIGS. 1-10 illustrate a foot peg 10 constructed in accordance with the present invention. According to an aspect of the present invention, the foot peg 10 is intended for use on a motorized vehicle 14. It is common for motorized vehicles 14 to include a seat which the rider straddles. As used herein, a motorized vehicle 14 may include, but is not limited to a motorcycle, all-terrain vehicle, and the like. Motorized vehicles 14 are drivable on driving surfaces. The driving surface defines a driving surface hardness. A driving surface may include, but is not limited to, a racetrack or a typical street.

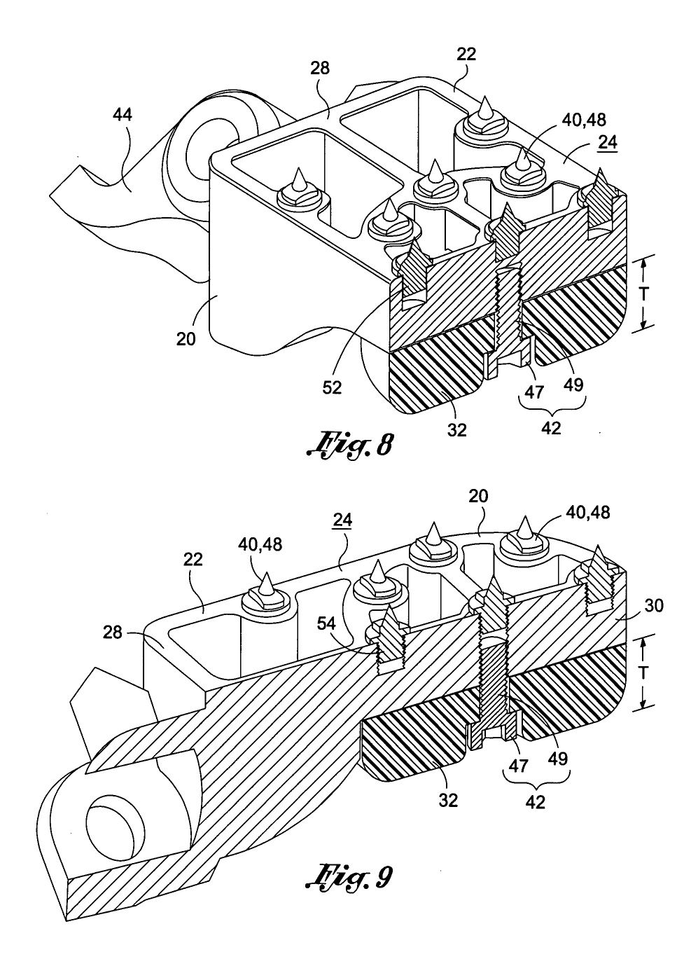

According to an embodiment of the present invention, the foot peg 10 includes a frame 20 having a frame body 22. The frame body 22 may be comprised of a strong, durable material, such as steel. However, other materials known in the art may also be used. The frame body 22 includes a frame top surface 24 and a frame bottom surface 26, as well as proximal and distal end portions 28, 30. The frame bottom surface 26 is best illustrated in FIG. 7. In that particular embodiment, the frame bottom surface 26 includes the circular portion of the frame body 22. The frame 20 is engageable with the boot of a rider. As used herein, a rider's boot may refer to any type of footwear worn by the rider. In this regard, the rider may rest his foot on the foot peg 10 to maintain a safe riding position.

The foot peg 10 further includes a mounting member 44 that is engageable with the motorized vehicle 14. The mounting member 44 is connected to the proximal end portion 28 of the frame body 22. According to one particular implementation of the present invention, the mounting member 44 is releasably engageable with the motorized vehicle 14. In this manner, the foot peg 10 may be easily detached from the motorized vehicle 14. It may be beneficial to detach the foot peg 10 from the motorized vehicle 14 to facilitate maintenance and repair of the foot peg 10 and/or the motorized vehicle 14.

Referring now specifically to the embodiment illustrated in FIG. 1, there is shown in phantom, a section of the motorized vehicle 14 which includes a bracket 12 that is releasably engageable with the mounting member 44. The mounting member 44 includes a first mounting hole 43, and the bracket 12 includes a second mounting hole 13. In order to attach the foot peg 10 to the motorized vehicle 14, the first mounting hole 43 is aligned with the second mounting hole 13. A pin 16 is placed through both the first and second mounting holes 43, 13. A pin lock 18 is inserted into the pin 16 to maintain the pin 16 within the first and second mounting holes 43, 13. When the pin 16 is inserted within the first and second mounting holes 43, 13, the foot peg 10 is connected to the motorized vehicle 14. In order to disconnect the foot peg 10 from the motorized vehicle 14, the pin lock 18 is simply removed from the pin 16, and the pin 16 is subsequently removed from the first and second mounting holes 43, 13. Although the above description describes the use of the pin 16 to attach the foot peg 10 to the motorized vehicle 14, it is understood that other attachment members known by those skilled in the art may also be used without departing from the spirit and scope of the present invention.

According to another aspect of the present invention, the mounting member 44 is pivotally connected to the motorized vehicle 14. In this regard, the foot peg 10 may pivot between a stowed position and a deployed position. In the deployed position, the foot peg 10 extends laterally from the motorized vehicle 14 and the frame top surface 24 is in an upwardly facing position relative to the driving surface. From the deployed position, the foot peg 10 pivots inwardly to the stowed position. In other words, the distal end portion 30 is disposed closer to the motorized vehicle 14 when the foot peg 10 is in the stowed position, and farther away from the motorized vehicle 14 when the foot peg 10 is in the deployed position. It is contemplated that the foot peg 10 may rotate downwardly from the stowed position and into the deployed position.

One embodiment of the mounting member 44 includes a contact portion 45 that is disposable in contact with the motorized vehicle 14 to prevent rotation of the foot peg 10 beyond the deployed position. Therefore, the contact portion 45 allows free rotation of the foot peg 10 between the stowed position and the deployed position; however, when the foot peg 10 reaches the deployed position, the contact portion 45 prevents any further rotation thereof.

It may be desirable to dispose the foot peg 10 between the stowed position and the deployed position. Therefore, one embodiment of the foot peg 10 includes a camber adjustment member 60 being engageable with the foot peg 10, as best illustrated in FIG. 10. The camber adjustment member 60 may be enageable with the mounting member 44. The camber adjustment member 60 is configured to dispose the foot peg 10 at a desired angular position relative to the motorized vehicle 14. The camber adjustment member 60 includes a camber head 62 and a camber shank 64. The camber shank 64 is engageable with the mounting member 44. The camber shank 64 may be threadingly engageable with an aperture formed within the mounting member 44. On the other hand, the camber shank 64 may also be pressed into the aperture formed within the mounting member 44. The camber adjustment member 60 is inserted into the foot peg 10 until the camber head 62 is adjacent to and abutting the mounting member 44. In this regard, the camber adjustment member 60 is completely screwed or pressed into the aperture on the mounting member 44.

It is contemplated that the camber adjustment member 60 may be available in different sizes, wherein each size is capable of disposing the foot peg 10 in a different angular position relative to the motorized vehicle 14. More specifically, camber adjustment members 60 having camber heads 62 with different thicknesses “H” may be used to achieve the desired angular position of the foot peg 10. A camber head 62 having a larger thickness H will dispose the foot peg 10 closer to the stowed position than a camber head 62 having smaller thickness H.

The foot peg 10 further includes a slider 32 that is attachable to the frame bottom surface 26. According to one embodiment, the slider 32 is attached to the distal end portion 30 of the frame body 22, as shown in FIGS. 1-4, and 7-9. The slider 32 is configured to sacrificially wear as the foot peg 10 comes in contact with the driving surface when the rider rides the motorized vehicle 14. To this end, the slider 32 defines a slider hardness that is less than the driving surface hardness. As a result, the slider 32 is configured to mitigate the scratching of the driving surface when there is abrasive contact between the slider 32 and the driving surface. Furthermore, since the slider 32 is positioned to contact the driving surface, the foot peg frame 20 is spared from contact with the driving surface. Given that the slider 32 may absorb all of the contact between the foot peg 10 and the driving surface, it may be desirable to minimize the thickness “T” of the slider 32 to reduce the number of contacts between the slider 32 and the driving surface. Minimizing the slider thickness T may increase the life of the slider 32.

The slider 32 may be comprised of a number of different materials having a hardness that is less than the driving surface hardness. According to one embodiment, the slider 32 is comprised of a plastic material having a hardness that is less than the driving surface hardness. In one particular implementation of the present invention, the slider 32 is comprised of acrylonitrile butadiene styrene (ABS), which has a shore hardness of about D 100. In another embodiment, the slider 32 is comprised of Delrin®, which is manufactured by DuPont, and has a shore hardness of about D 86. In still another implementation of the invention, the slider 32 is comprised of high density polyethylene which has a shore hardness of about D 55-69. Therefore, according to various aspects of the present invention, the slider 32 may be comprised of a material having a shore hardness that is less than D 100. Although ABS, Delrin®, and high density polyethylene are discussed above as exemplary materials which may be used to construct the slider 32, it is understood that other materials known by those having skill in the art may also be used.

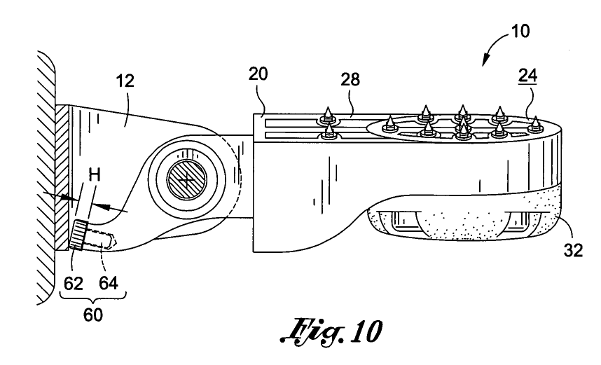

The slider 32 is attached to the frame 20 and is disposed adjacent to the frame bottom surface 26. The slider 32 may be attached to the frame 20 via a capscrew 42. The capscrew 42 is configured to threadingly engage with an aperture disposed within the frame body 22. The capscrew 42, as best shown in FIGS. 7-9, includes a threaded portion 49 and a head portion 47. The threaded portion 49 defines a threaded diameter “d₁” that is less than the head diameter “d₂.” The slider 32 includes a capscrew receiving hole 56 defining a diameter that is slightly greater than the threaded diameter d₁, and less than the head diameter d₂ of the capscrew 42. In this manner, the capscrew receiving hole 56 is configured to allow the threaded portion 49 to pass through, but does not allow the head portion 47 to pass through. Therefore, the threaded portion 49 may pass through the capscrew receiving hole 56 and threadingly engage with the frame body 22, thereby securing the slider 32 to the frame bottom surface 26, as shown in FIGS. 8-9. Although the foregoing describes attachment of the slider 32 to the frame body 22 via a capscrew 42, it is understood that other means of fastening the slider 32 to the frame body 22 known by those having skill in the art may also be used. For instance, the slider 32 itself may include threads to enable threaded engagement directly between the slider 32 and the frame body 22.

According to another aspect of the invention, the slider 32 releasably attaches to the frame bottom surface 26. In this regard, the slider 32 may be removed from the foot peg 10. It may be desirable to remove the slider 32 after repeated use has rendered the slider 32 ineffective. Therefore, it is not necessary to replace the entire foot peg 10 after repeated contact with the driving surface, as is typically required in most prior art foot pegs 10. Rather, an aspect of the present invention enables the ineffective slider 32 to be removed from the frame 20 to allow replacement with a new slider 32. In the embodiment described above wherein the slider 32 is attached to the frame 20 via a capscrew 42, the slider 32 may be easily removed from the frame 20 by unscrewing the capscrew 42 therefrom.

In another embodiment, the slider 32 may include a radial receiving hole 58 configured to receive a radial screw 46. A radial screw 46 may be used to further secure the slider 32 to the frame bottom surface 26. The radial screw 46 is similar to the capscrew 42 in that it also includes a threaded portion 53 having a threaded diameter “d₃” that is less than a head diameter “d₄.” The radial receiving hole 58 is similar to the capscrew receiving hole 56 in that it is configured to allow the threaded portion 53 of the radial screw 46 to pass through, but does not allow the head portion 51 to pass through.

It is contemplated that as the rider tilts the motorized vehicle 14, only a portion of the slider 32 may contact the driving surface. Consequently, the slider 32 may not uniformly wear as it repeatedly contacts the driving surface. Rather, one portion of the slider 32 may wear more than the remainder of the slider 32. This is particularly true when the slider 32 contacts the driving surface at an angle. In that case, the distal-most portion of the slider 32 may contact the driving surface at a higher frequency, while a proximal portion of the slider 32 may not contact the driving surface at all. Therefore, it may be desirable to rotate the slider 32 between uses to distribute the wear of the slider 32. As such, the slider 32 may include a plurality of radial receiving holes 58 to enable a user to rotate the worn portion away from contact with the driving surface, thereby rotating a “fresh” portion of the slider 32 into position to contact the driving surface. FIGS. 2, 4, and 7 best illustrate a slider 32 having a plurality of radial receiving holes 58. In the particular embodiment depicted in FIGS. 2, 4, and 7, the slider 32 includes four radial receiving holes 58, which enables the slider 32 to be rotated into four different positions. As such, the slider 32 may be rotated ninety degrees to rotate another portion of the slider 32 into position to contact the driving surface. FIG. 2 illustrates an embodiment including four radial screws 46. In contrast, FIGS. 4 and 7 illustrate an embodiment using only one radial screw 46, even though there are four radial receiving holes 58. Although the above description describes embodiments with one or four radial screws 46, it is understood that any number of radial screws 46 and radial receiving holes 58 may be used without departing from the spirit and scope of the present invention.

Although the capscrew 42 and radial screw(s) 46 may be used to attach the slider 32 to the frame 20, the capscrew 42 and radial screw 46 may be comprised of a material having a hardness that is greater than the driving surface hardness. Consequently, the capscrew 42 and/or radial screw 46 may scratch the driving surface if they come into contact with the driving surface. Therefore, one particular embodiment includes a slider 32 having a central recessed notch 34 configured to receive the capscrew 42. In this regard, the capscrew 42 does not protrude outside of the central recessed notch 34. Similarly, another embodiment of the invention includes a slider 32 having a radial recessed notch 36 or a plurality of radial recessed notches 36 configured to receive the radial screw(s) 46 to prevent the radial screw(s) 46 from protruding beyond the radial recessed notch 36.

Although rotating the slider 32 may distribute the wear sustained by the slider 32, long and repeated use may render the entire slider 32 ineffective. As such, it is contemplated that the worn slider 23 may be replaced with a new slider 32. The worn slider 32 is removed from the frame 20, and the new slider 32 is attached thereto. In this regard, the user is not required to replace an entire foot peg 10 when the slider 32 is rendered ineffective. The user may simply remove the old slider 32 and replace it with a new slider 32.

As mentioned above, the foot peg 10 is configured to engage the boot of a rider. It is contemplated that traction between the foot peg 10 and the rider's boot may be inhibited by dirt or moisture buildup on the frame 20. Consequently, the rider's boot may slip off of the foot peg 10, which may cause the rider to lose his balance. Therefore, one aspect of the invention includes a frame 20 having a grip stud 40 connected to the frame body 22. One embodiment of the invention includes a frame 20 having a plurality of grip studs 40 connected to the frame body 22, as illustrated in FIGS. 1, 3, 4, and 7-9. The grip studs 40 may be arranged in a variety of different configurations. The grip stud(s) 40 provide enhanced traction between the rider's boot and the foot peg 10.

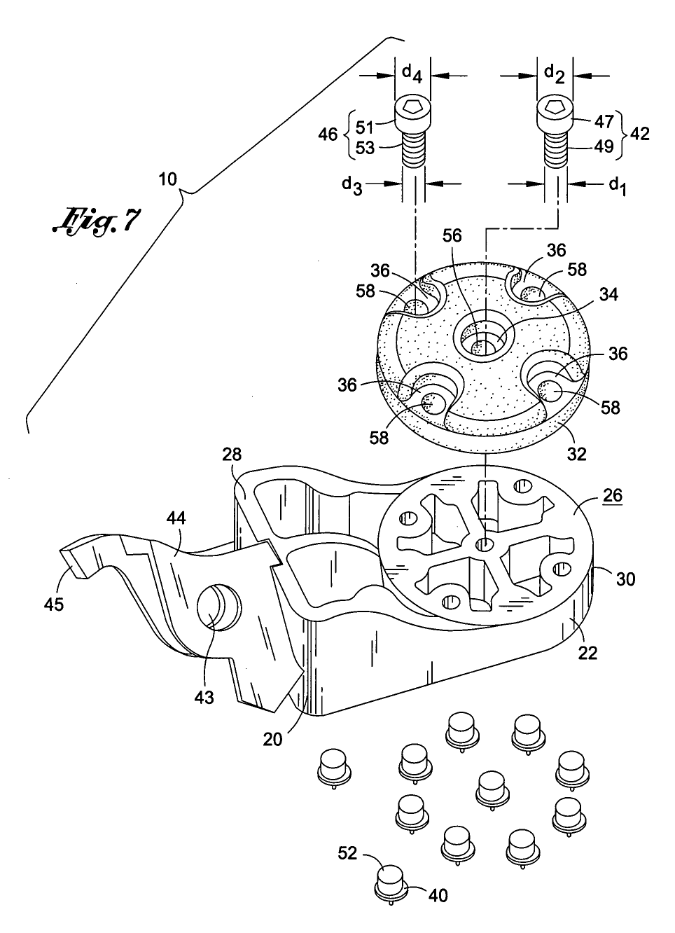

According to various aspects of the present invention, the grip stud(s) 40 may be configured in a variety of different shapes, depending on the type and amount of traction that the user desires. One implementation of the invention includes pointed grip studs 48, as best shown in FIG. 5, while another implementation of the invention includes flat-end grip stud(s) 50, as best illustrated in FIG. 6. It is also contemplated that the grip stud 20 may include a conventional track spike configured for use on a track shoe. However, it is understood that other grip studs 40 known by those skilled in the art may be used.

The grip studs 40 may engage with the frame body 22 in a number of different ways. For instance, the grip stud 40 may threadingly engage with the frame body 22. As such, the grip stud 40 may include a threaded connector 54 which engages with a threaded aperture formed in the frame body 22. In addition to the threaded engagement, the grip stud 40 may engage with the frame 20 by being pressed into the frame body 22. As such, the grip studs 40 may include a press fit connector 52 which may be pressed into the apertures formed on the frame body 22. When the press fit connector 52 is pressed into the frame body 22, the grip stud 40 is securely attached thereto.

It may be desirable to use grip studs 40 having different heights for different conditions. To this end, the grip studs 40 may be removable to enable grip studs 40 having a height desired by the user to be inserted into the foot peg 10. In the case of the grip stud 40 having the threaded connector 54, the grip stud 40 may be unscrewed from the frame body 22, and another grip stud 40 having the desired dimensions may be screwed therein. Similarly, in the case of the grip stud 40 having the press-fit connector 52, the grip stud 40 may be removed from the frame body 22, and another grip stud 40 may be pressed therein.

Although the foregoing describes a foot peg 10 having removable grip studs 40, it is understood that the grip studs 40 may be integrally molded into the frame body 22 without departing from the spirit and scope of the present invention.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A foot peg for use on a motorized vehicle being drivable on a driving surface, the driving surface defining a driving surface hardness, the foot peg comprising:
a frame being configured to engage a boot of a rider, the frame including a frame body having a frame top surface, a frame bottom surface, and proximal and distal end portions, the frame top surface being disposable in an upwardly facing position relative to the driving surface;
a slider being attached to the frame bottom surface at the distal end portion, the slider defining a slider hardness less than the driving surface hardness; and
a mounting member connected to the proximal end portion of the frame body, the mounting member being engageable with the motorized vehicle.

2. The foot peg as recited in claim 1 wherein the frame further includes a grip stud connected to the frame body, at least a portion of the grip stud extending above the frame top surface when the grip stud is attached to the frame body, the grip stud being configured to engage the boot of the rider.

3. The foot peg as recited in claim 2 wherein the grip stud is releasably attachable to the frame body.

4. The foot peg as recited in claim 3 wherein the grip stud is threadingly engageable with the frame body.

5. The foot peg as recited in claim 1 wherein the slider further comprises a capscrew hole disposed therein.

6. The foot peg as recited in claim 5 further including a capscrew being insertable into the capscrew hole and threadingly engageable with the frame body to releasably attach the slider to the frame bottom surface.

7. The foot peg as recited in claim 5 wherein the slider further includes a radial screw hole disposed therein.

8. The foot peg as recited in claim 7 further comprising a plurality of radial screw holes disposed therein.

9. The foot peg as recited in claim 7 further comprising a radial screw being insertable into the radial screw hole and threadingly engageable with the frame body.

10. The foot peg as recited in claim 1 wherein the slider is comprised of a plastic material.

11. The foot peg as recited in claim 10 wherein the slider is comprised of ABS.

12. The foot peg as recited in claim 10 wherein the slider is comprised of DELRIN.

13. The foot peg as recited in claim 10 wherein the slider is comprised of high density polyethylene.

14. The foot peg as recited in claim 1 wherein the slider is comprised of a material having a shore hardness of about D55-D100.

15. The foot peg as recited in claim 1 wherein the mounting member is pivotally attachable to the motorized vehicle.

16. The foot peg as recited in claim 1 further comprising a camber adjustment member having a camber head connected to a camber shank, the camber shank being connectable to the mounting member, the camber head being positionable in abutting contact with the motorized vehicle.

17. A foot peg for use on a motorized vehicle being drivable on a driving surface, the driving surface defining a driving surface hardness, the foot peg comprising:
a frame including a frame body having a frame top surface, a frame bottom surface, and proximal and distal end portions, the frame top surface being disposable in an upwardly facing position relative to the driving surface, the frame including a grip stud connected to the frame body, at least a portion of the grip stud extending above the frame top surface when the grip stud is attached to the frame body, the frame being configured to engage the boot of the rider;
a slider being attached to the frame bottom surface at the distal end portion, the slider defining a slider hardness less than the driving surface hardness; and
a mounting member connected to the proximal end portion of the frame body, the mounting member being engageable with the motorized vehicle.

18. The foot peg as recited in claim 16 wherein the slider is comprised of a plastic material.

19. The foot peg as recited in claim 17 wherein the slider is comprised of ABS.

20. The foot peg as recited in claim 16 wherein the slider is comprised of a material having a shore hardness of about D55-D100.
